(19) United States
(12) Patent Application Publication
(10) Pub. No.: US 2024/0119308 A1
(43) Pub. Date: Apr. 11, 2024

(54) SYSTEMS AND METHODS FOR MODEL-BASED META-LEARNING

(71) Applicant: Salesforce, Inc., San Francisco, CA (US)

(72) Inventors: Arundhati Banerjee, Pittsburgh, PA (US); Stephan Zheng, Redwood City, CA (US); Soham Phade, Mountain View, CA (US); Stefano Ermon, Menlo Park, CA (US)

(21) Appl. No.: 18/159,036

(22) Filed: Jan. 24, 2023

Related U.S. Application Data
(60) Provisional application No. 63/377,502, filed on Sep. 28, 2022.

(51) Int. Cl. G06N 3/0985

(52) U.S. Cl. CPC G06N 3/0985

(57) ABSTRACT

Embodiments provide a method for predicting agent actions for neural network based agents according to an intervention. The method includes obtaining a first agent action at a first time step and a first intervention generated according to an intervention policy. The method also includes generating, by the neural network based agent model, a predicted agent action conditioned on the first agent action and the first intervention. The method also includes generating, by a neural network based intervention model, a second intervention according to the intervention policy and conditioned on the first agent action, the first intervention, and the predicted agent action. The method further includes executing a second agent action according to an agent policy that incurs a reward based on the second intervention. The method further includes training the neural network based intervention model by updating parameters of the neural network based intervention model based on an expected return.

### CROSS REFERENCE(S)

The instant application is a nonprovisional of and claim priority under 35 U.S.C. 119 to U.S. provisional application No. 63/377,502, filed on Sep. 28, 2022, which is hereby expressly incorporated by reference herein in its entirety.

### TECHNICAL FIELD

The embodiments relate generally to machine learning systems, and more specifically to systems and methods for model-based meta-learning.

### BACKGROUND

Mechanism design studies how to design a gaming system, e.g., the reward functions and environment rules, that are implemented by a set of intelligent agents, such as chatbots, or agents in other forms. Such design mechanism can be widely applied across many domains, e.g., maximizing revenue in auctions, optimizing social welfare with economic policy, or optimizing skill acquisition in personalized education. However, real-world agents, e.g., an individual human agent who moderates auctions, makes decisions in social welfare systems, and/or the like, may often behave and learn differently than existing intelligent agents simulated under a given mechanism design. Additionally, the execution of the designed mechanism can be costly.

Therefore, there is a need for robust adaptive and efficient mechanism design.

### BRIEF DESCRIPTION OF THE DRAWINGS

FIG. 1A is a simplified diagram illustrating an exemplary model-based meta-learning framework, according to some embodiments.

FIG. 1B is a simplified diagram illustrating observables, rewards, and actions in the model-based meta-learning framework, according to some embodiments.

FIG. 2 is a simplified diagram illustrating a computing device implementing the model-based meta-learning framework described in FIGS. 1A, 1B, 3, 4A, 4B, 5A-5D, and 6, according to some embodiment described herein.

FIG. 3 is a simplified block diagram of a networked system suitable for implementing the model-based meta-learning framework described in FIGS. 1A, 1, 2, 4A, 4B, 5A-5D, and 6 and other embodiments described herein.

FIG. 4A illustrates a flowchart of a method for training the model-based meta-learning framework, according to some embodiments.

FIG. 4B illustrates a flowchart of another method for training process of the model-based meta-learning framework, according to some embodiments.

FIG. 5A illustrates an exemplary algorithm for the training of a model-based meta-learning framework, according to some embodiments.

FIG. 5B illustrates a flowchart of the training illustrated in FIG. 5A, according to some embodiments.

FIG. 5C illustrates an exemplary algorithm for the testing and evaluating of a model-based meta-learning framework, according to some embodiments.

FIG. 5D illustrates a flowchart of a test-time learning by the model-based meta-learning framework illustrated in FIG. 5A, according to some embodiments.

FIG. 6 provides charts illustrating exemplary performance of different embodiments described herein.

Embodiments of the disclosure and their advantages are best understood by referring to the detailed description that follows. It should be appreciated that like reference numerals are used to identify like elements illustrated in one or more of the figures, wherein showings therein are for purposes of illustrating embodiments of the disclosure and not for purposes of limiting the same.

### DETAILED DESCRIPTION

As used herein, the term “network” may comprise any hardware or software-based framework that includes any artificial intelligence network or system, neural network or system and/or any training or learning models implemented thereon or therewith.

As used herein, the term “module” may comprise hardware or software-based framework that performs one or more functions. In some embodiments, the module may be implemented on one or more neural networks. For example, an agent module may comprise a neural network based agent model that predicts agent actions, and/or processor-based front-end agent circuitry that samples and executes an agent action according to the predictions. Similarly, an intervention module may comprise a neural network based intervention model that predicts an intervention, and/or processor-based front-end intervention circuitry that carries out an intervention according to the invention prediction.

Mechanism design (MD) studies how rules and rewards shape the behavior of intelligent agents, e.g., in auctions or the economy. Simulations with artificial intelligence (AI) agents are powerful tools for MD, but real-world agents may behave and learn differently than simulated agents under a given mechanism. Also, the mechanism designer may not fully observe an agent's learning strategy, and executing a mechanism may be costly, e.g., enforcing a tax might require extra labor. Hence, there is a need to provide robust adaptive mechanisms that may be adapted to agents with unseen (learning) behavior, are few-shot adaptable, and are cost-efficient.

In view of the need for a robust adaptive mechanism, embodiments described herein provide systems and methods for a model-based adaptive learning framework that combines reinforcement learning and meta-learning. The learning framework may be adapted to out-of-distribution agents with different learning strategies and reward functions, thereby reducing the cost of learning. Specifically, the model-based meta-learning framework include a neural network based agent model (e.g., also referred to as a “world model”) that simulates the behavior or learning strategy of an agent, and a neural network based intervention model that simulates the intervention or learning strategy of a principal (e.g., also referred to as a “planner”). For example, the neural network based agent model and the neural network based intervention model may be conditioned on respective states to respectively simulate the actions taken by an agent and a principal/intervention at inputs (e.g., observables).

In this disclosure, “neural network based agent model” is used interchangeably with “agent model,” and “neural network based intervention model” is used interchangeably with “intervention model.”

In one embodiment, the agent model is configured to output agent actions that follows a learning strategy (e.g., a learning algorithm), and the intervention model is configured to output interventions of an improved/optimized intervention policy that can adapt to the agent actions. The agent, through the learning strategy, aims to maximize its reward under intervention over a plurality of time steps. The planner, through optimizing its intervention policy, aims to maximize its expected return in response to the agent action over the time steps.

The learning framework may be trained on a plurality of agents (e.g., training agents or tasks). States representing past agent actions and past interventions may be the input of the learning framework. Specifically, the agent model may predict an agent action based on observed past actions (e.g., agent actions and interventions), and the intervention model may generate an intervention at a cost based on the observed past actions and the predicted agent action. The agent model may execute (e.g., sample) an agent action from its policy/distribution that incurs the agent's reward under the intervention. Based on the reward, the agent policy is updated (e.g., by an agent submodule of the learning framework) to maximize the agent's reward for the next time step. An intervention submodule updates the intervention policy to maximize the principal's expected return based on the incurred rewards for a plurality of time steps. For each agent, the intervention model collects rollout for meta-update. After the learning framework is trained on all agents, the intervention model further updates the intervention policy using collected rollouts of the agent model for all agents. In some embodiments, a reinforcement learning is employed to learn the agent model based on the interactions between the agent model and the intervention model. The intervention model then trains based on the learning of the agent model by using a gradient-based meta-learning. The trained framework can then have a generalized/optimized intervention policy to adapt to agents (e.g., test agents) having policies/distributions different from those for training. The trained intervention model can then be few-shot adaptable to unseen test agents.

Embodiments described herein provide a number of benefits. Specifically, the learning framework provides a novel way to optimize a principal's intervention policy for a learning agent. By using/updating states (e.g., parameters) of the agent model and the intervention model, the disclosed framework can simulate a learning agent, a learning principal, and the adaption of the principal to the agent. The intervention policy can thus be generalized to be a cost-effective mechanism that is K-shot adaptable with only partial information about the agents, K being a small positive integer such as 1, 2, 3, and/or the like. Even for learning agent having out-of-distribution actions or unseen explore-exploit behaviors, the principal can learn with only a few interactions, reducing the cost for real-world experiment. As such, the model-based meta-learning framework is a promising simulation-based approach to learn robust adaptive mechanisms with strong few-shot generalization in the real world.

### Overview

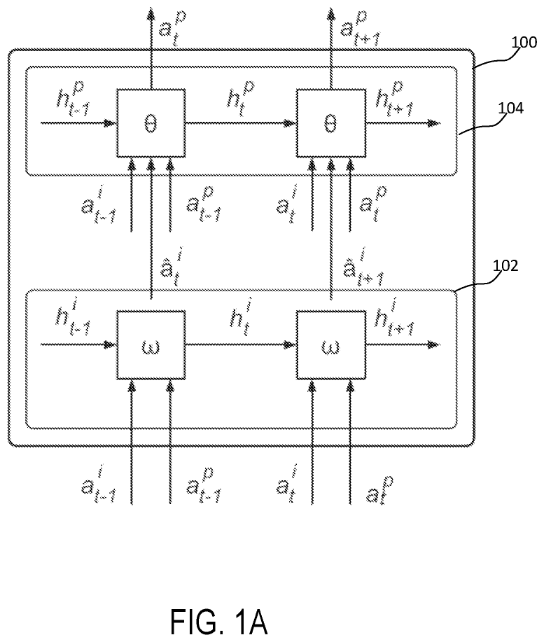

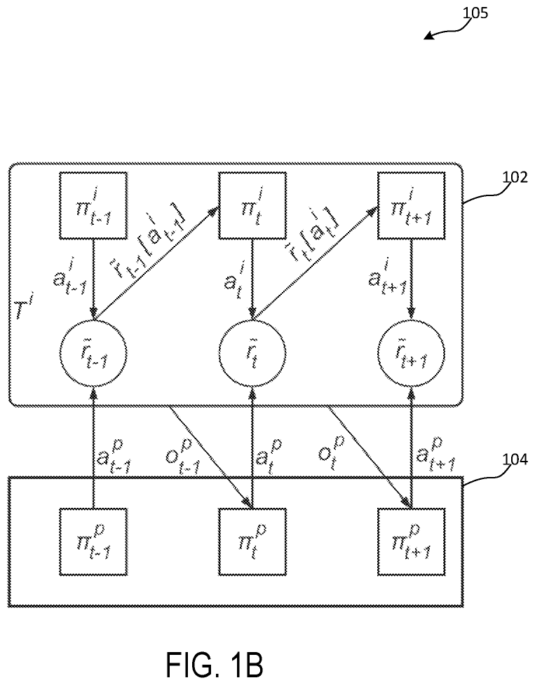

FIG. 1A is a simplified diagram illustrating a model-based meta-learning framework 100 (or framework 100) comprising an agent model 102 and an intervention model 104, according to some embodiments. FIG. 1B illustrates an example diagram of data flow 105 of observables, rewards, and actions between agent model 102 and intervention model 104 in framework 100, according to some embodiments. For ease of illustration, FIGS. 1A and 1B are described together.

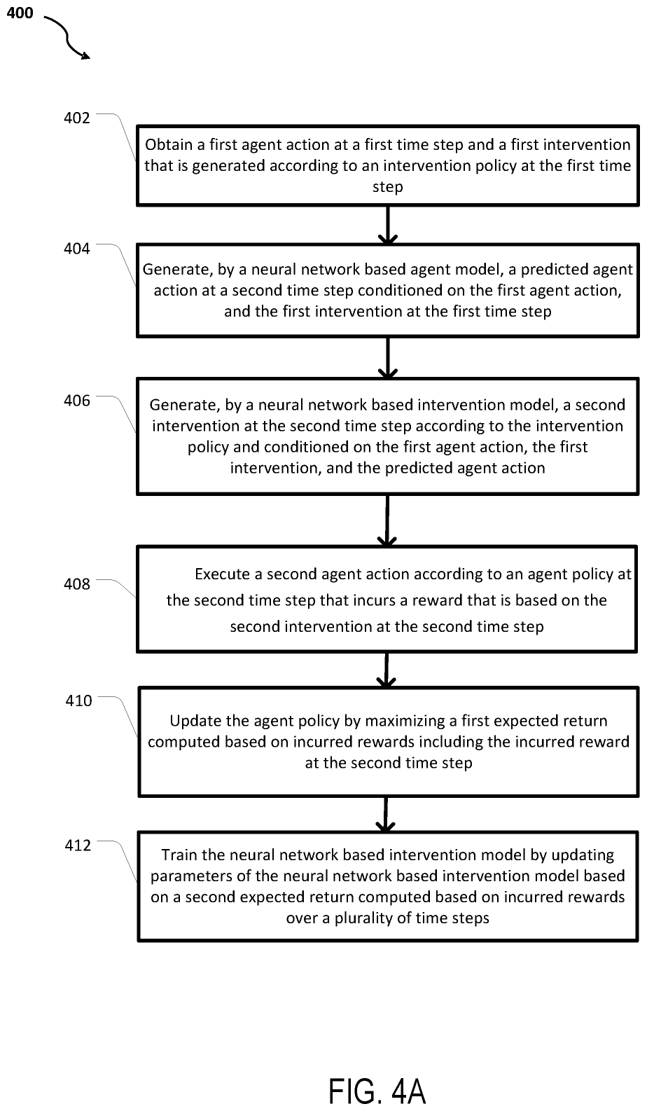

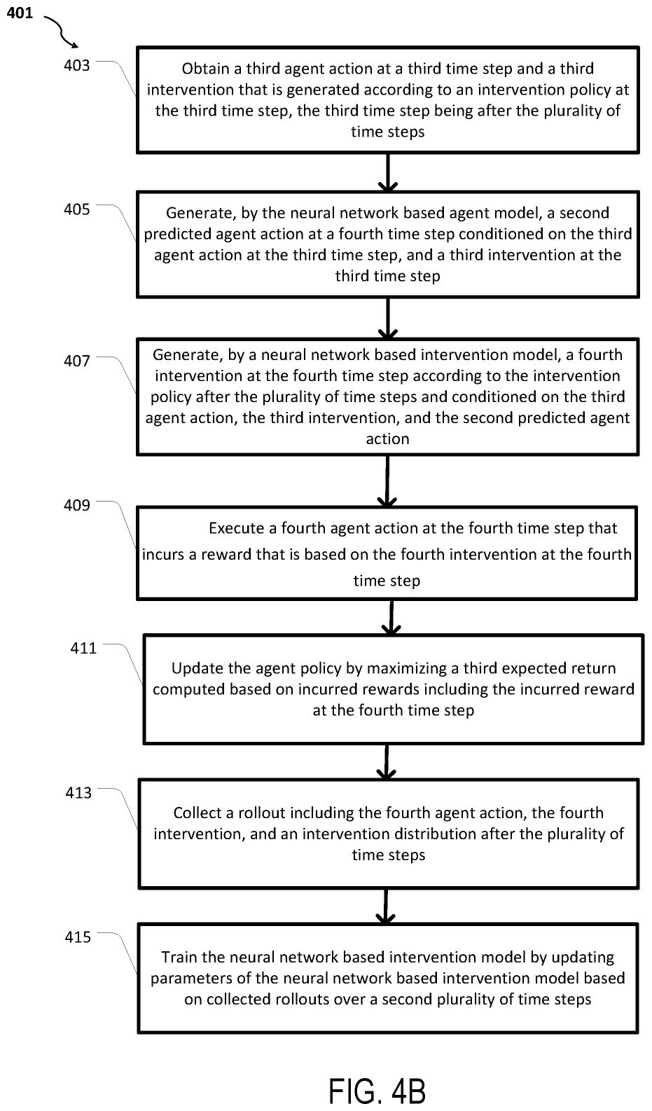

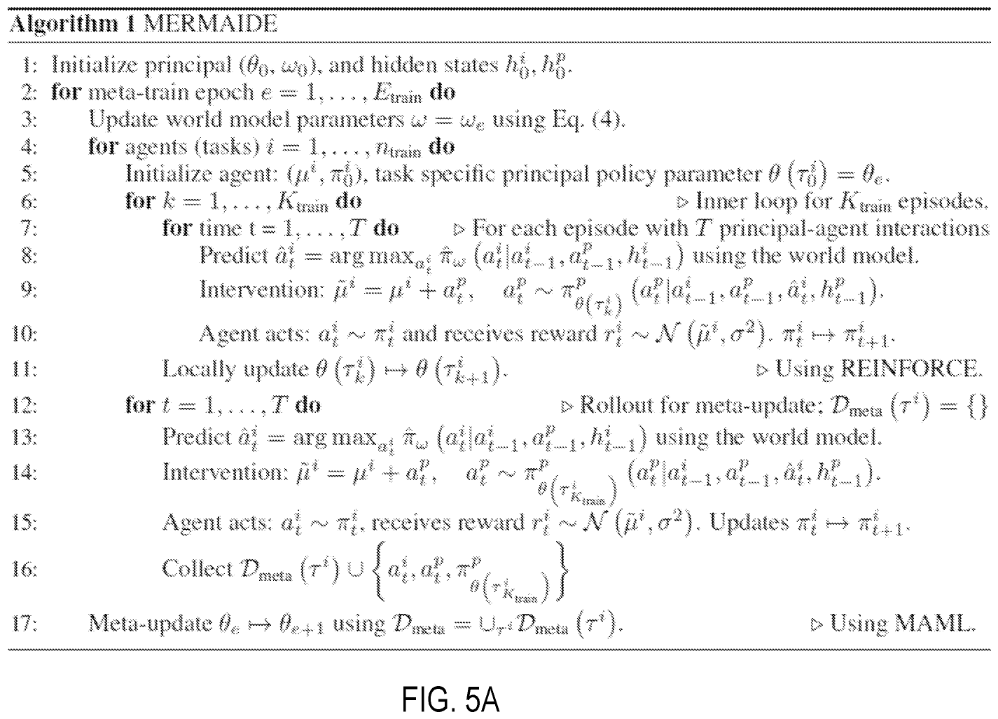

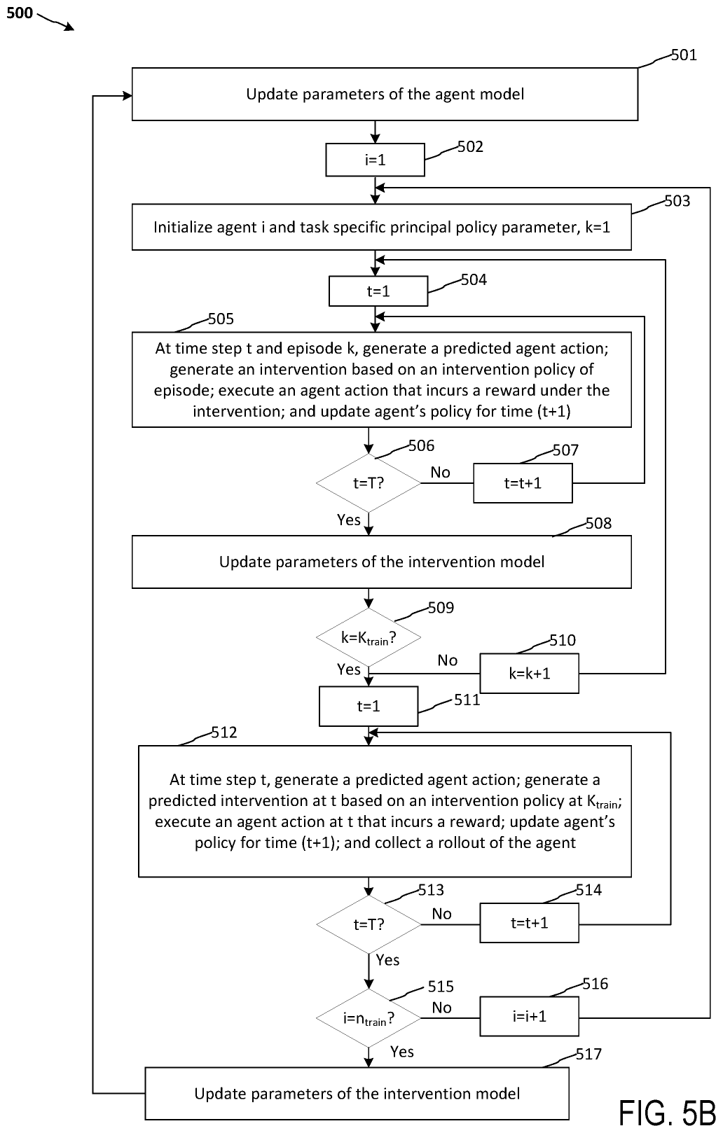

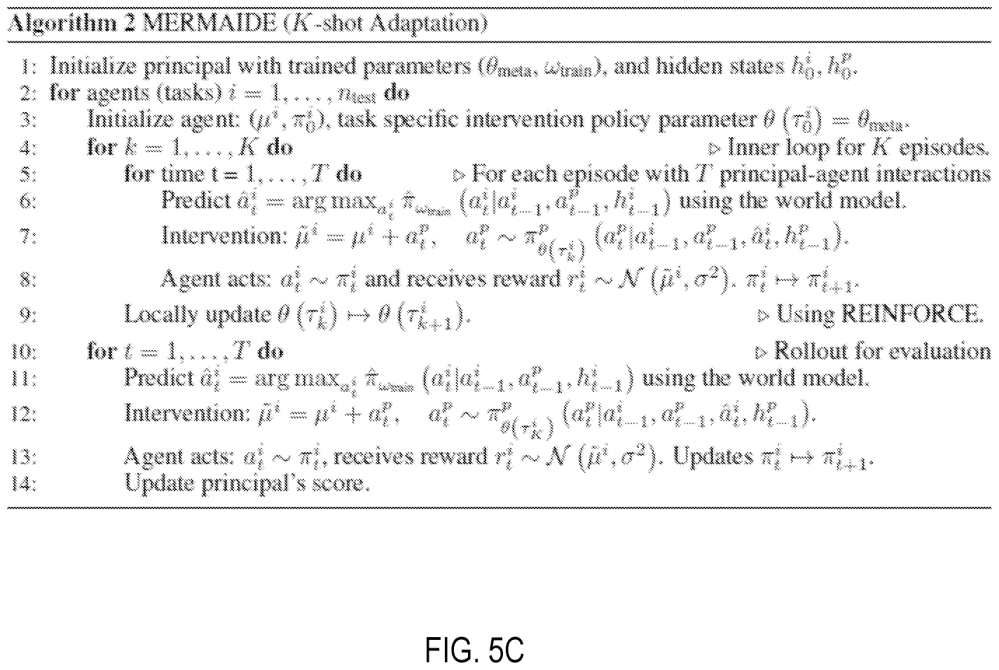

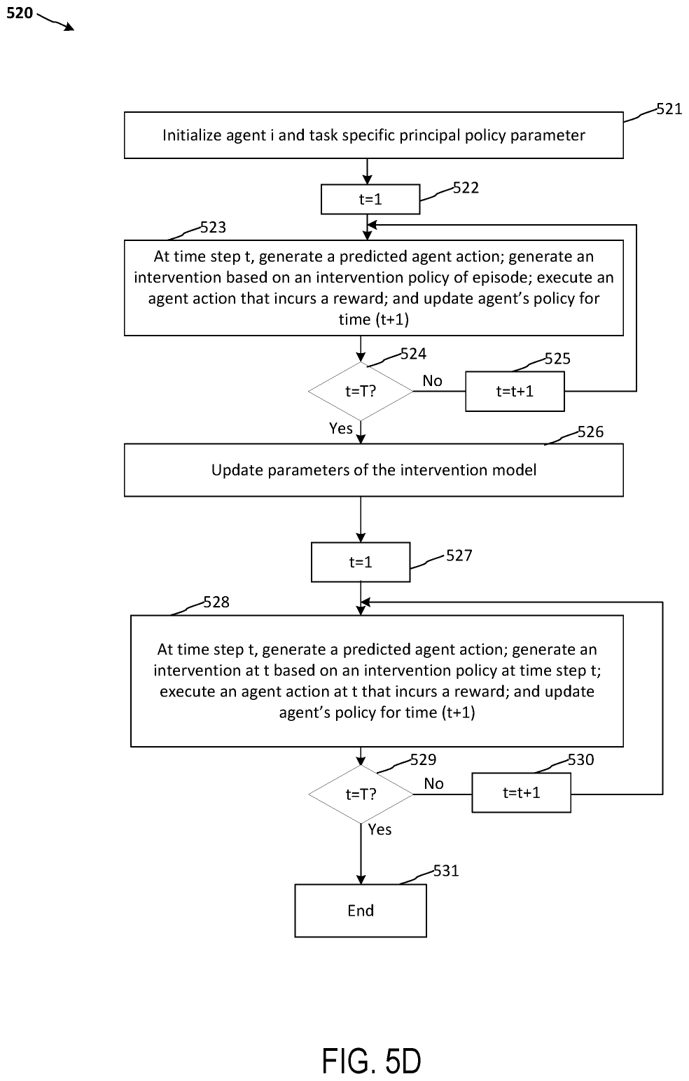

As shown in FIG. 1A, framework 100 comprises agent model 102 (e.g., a neural network based agent model) represented by its parameters w and an intervention model 104 (e.g., a neural network based intervention model) represented by its parameters θ. Agent model 102 and intervention model 104 are operatively connected to each another. The agent model 102 simulates the agent action/behavior using certain observables/states from flow 105, and the intervention model 104 simulates the principal action/behavior using certain observables/states shown in data flow 105 in FIG. 1B. Framework 100 may then simulate intervention-agent interactions using the agent model 102 and the intervention model 104 conditioned on the states. Details of the interactions and learning process are described below in relation to FIGS. 4A, 4B, and 5A-5D.

In one embodiment, agent model 102 may be used to simulate the actions/behaviors of an agent. Agent model 102 may include a recurrent neural network parameterized by ω. For time step t, the input of agent model 102 may include aₜ₋₁ⁱ (i.e., the agent action at time step (t−1)), and aₜ₋₁^{p} (i.e., the intervention at time step (t−1)). Agent model 102 may output a distribution over an agent i's actions at time step t: \hat{π}_{ω}(aₜⁱ|aₜ₋₁ⁱ, aₜ₋₁^{p}, hₜ₋₁ⁱ), conditioned on the intervention and the observed agent action at time step (t−1), and hₜ₋₁ⁱ (i.e., the hidden state of agent model 102).

Intervention model 104 may be used to simulate the actions/interventions of a principal/planner that intervenes the agent action. Intervention model 104 may include a recurrent neural network parameterized by θ. The input of intervention model 104 may include aₜ₋₁ⁱ (i.e., the agent action at time step (t−1)), aₜ₋₁^{p} (i.e., the intervention at time step (t−1)), and âₜⁱ (i.e., the predicted agent action at time step t). Intervention model 104 may output a distribution over interventions aₜ^{p}˜π_{θ}^{p}(aₜ^{p}|aₜ₋₁ⁱ, aₜ₋₁^{p}, âₜⁱ, hₜ₋₁^{p}), conditioned on previous interventions, the observed agent action, and the predicted agent action at time step t: âₜⁱ=maxₐ\hat{π}_{ω}(a|aₜ₋₁ⁱ, aₜ₋₁^{p}, hₜ₋₁^{p}), and hₜ₋₁^{p} (i.e., the hidden state of intervention model 104). The predicted agent action âₜⁱ may be generated by agent model 102.

FIG. 1B explains the intervention-agent interaction for a plurality of time steps and the observables involved/generated the interaction. Intervention model 104 is conditioned on a plurality of states (e.g., settings), and agent model 102 is conditioned on a plurality of states. The observables in FIG. 1B may be used (e.g., as inputs) in the training of framework 100 shown in FIG. 1A.

As shown in FIG. 1B, τⁱ represents agent i (e.g., each agent is represented as a task τ), which is characterized by its action space A and a reward function r: A→ [symbol] . Under invention model 104's intervention, agent model 102 may experience an intervened reward \tilde{r}ₜ(aₜ)=r(aₜ)+r′ₜ(aₜ). At time step t, πₜ a distribution over its actions based on observations up to time step t may be computed based on agent's policy. An agent action at may be executed/sampled from the distribution aₜ˜πₜ by agent model 102. It may be assumed that intervention model 104 has a preferred action a* that agent model 102 should execute, but the agent policy can prefer a different action than a* without intervention. At time step t, under intervention model 104's intervention, the agent policy may be updated using an update rule ƒ: (πₜ, aₜ, \tilde{r}ₜ) [symbol] πₜ₊₁ to maximize agent model 102's intervened rewards over a plurality of time steps. In an embodiment, rule ƒ updates the confidence bounds for the agent action selected from the distribution at time step t.

Intervention model 104 may be modeled as POMDP (S, o^{p}, A^{p}, r^{p}, γ, P). o^{p} represents an observation function that determines the part of an agent state s is visible to intervention model 104, represented by intervention model 104. A^{p} represents the action space of the interventions. r^{p} represents intervention model 104's reward. γ represents a discount factor. P represents the environment dynamics, e.g., as caused by agent model 102's actions. At time step t, an action/intervention aₜ^{p}˜π^{p}(aₜ^{p}|oₜ₋₁^{p}, hₜ₋₁^{p}), may be generated/selected. The intervention determines intervention model 104's intervention on a possible agent action a, e.g., aₜ^{p}=[r′₁ . . . , r′_{|A|}]. In some embodiments, the agent's intervened reward may not be fully visible (e.g., be only partially) to intervention model 104. Intervention model 104, based on the agent's partially visible intervened reward, may generate an intervention at a cost that maximizes/increases intervention model 104's expected return over a plurality of time steps.

For example, as shown in FIG. 1B, at time step (t−1), agent model 102 may select an agent action aₜ₋₁ⁱ from agent policy πₜ₋₁ⁱ, and intervention model 104 may select an intervention (or action) aₜ₋₁^{p} from intervention policy πₜ₋₁^{p}. Under intervention model 104's intervention aₜ₋₁^{p}, agent model 102 may experience an intervened reward \tilde{r}ₜ₋₁, e.g., as a result of the aₜ₋₁^{p} and agent model 102's action aₜ₋₁ⁱ. The agent policy πₜⁱ may be updated for time step t using the intervened reward \tilde{r}ₜ₋₁, while the intervention policy πₜ^{p} may be updated for time step t based on the observation function oₜ₋₁^{p} at time step (t−1). At time step t, agent model 102 may select an action at from agent policy πₜⁱ. Intervention model 104 may select an intervention (or action) aₜ^{p} from intervention policy πₜ^{p}. Under intervention model 104's intervention aₜ^{p}, agent model 102 may experience an intervened reward it, e.g., as a result of the aₜ^{p} and agent model 102's action aₜⁱ. The agent policy πₜ₊₁ⁱ may be updated for time step (t+1) based on the intervened reward \tilde{r}ₜ, while the intervention policy πₜ₊₁^{p} may be updated for time step (t+1) based on the observation function oₜ^{p} at time step t. Agent model 102 and intervention model 104 may repeat the interaction for a plurality of time steps, and/or until agent model 102's action is sufficiently close to intervention model 104's preferred agent action a*. For example, the interaction may stop when the agent action and a* is sufficiently close. Detailed description of the training process is provided in below.

Referring back to FIG. 1A, observables generated in the intervention-agent interaction may be used as input of framework 100 for simulating the intervention-agent interaction using neural network models. For example, the actions of intervention model 104 and agent model 102 at a plurality of time steps, e.g., aₜ₋₁ⁱ, aₜ₋₁^{p}, aₜⁱ, aₜ^{p}, may be fed into agent model 102. Intervention model 104 may output interventions, e.g., aₜ^{p}, aₜ₊₁^{p}, in response to the output of agent model 102, e.g., âₜⁱ, âₜ₊₁ⁱ, and aₜ₋₁ⁱ, aₜ₋₁^{p}, aₜⁱ, aₜ^{p}. Framework 100 may train to simulate the learning of agent model 102 and optimize the intervention policy of intervention model 104 in response to agent model 102's learning behavior.

### Computer and Network Environment

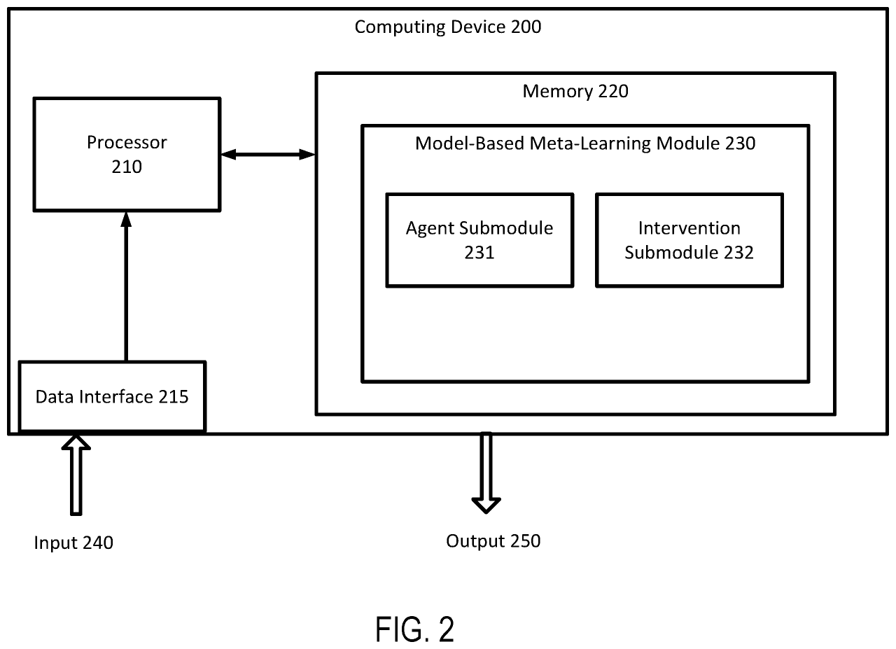

FIG. 2 is a simplified diagram illustrating a computing device implementing the model-based meta learning described in FIGS. 1A, 1, 3, 4A, 4B, 5A-5D, and 6, according to one embodiment described herein. As shown in FIG. 2, computing device 200 includes a processor 210 coupled to memory 220. Operation of computing device 200 is controlled by processor 210. And although computing device 200 is shown with only one processor 210, it is understood that processor 210 may be representative of one or more central processing units, multi-core processors, microprocessors, microcontrollers, digital signal processors, field programmable gate arrays (FPGAs), application specific integrated circuits (ASICs), graphics processing units (GPUs) and/or the like in computing device 200. Computing device 200 may be implemented as a stand-alone subsystem, as a board added to a computing device, and/or as a virtual machine.

Memory 220 may be used to store software executed by computing device 200 and/or one or more data structures used during operation of computing device 200. Memory 220 may include one or more types of machine-readable media. Some common forms of machine-readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Processor 210 and/or memory 220 may be arranged in any suitable physical arrangement. In some embodiments, processor 210 and/or memory 220 may be implemented on a same board, in a same package (e.g., system-in-package), on a same chip (e.g., system-on-chip), and/or the like. In some embodiments, processor 210 and/or memory 220 may include distributed, virtualized, and/or containerized computing resources. Consistent with such embodiments, processor 210 and/or memory 220 may be located in one or more data centers and/or cloud computing facilities.

In some examples, memory 220 may include non-transitory, tangible, machine readable media that includes executable code that when run by one or more processors (e.g., processor 210) may cause the one or more processors to perform the methods described in further detail herein. For example, as shown, memory 220 includes instructions for model-based meta-learning module 230 that may be used to implement and/or emulate the systems and models, and/or to implement any of the methods described further herein. Model-based meta-learning module 230 may receive input 240 such as an input training data (e.g., states of one or more past tasks/agent actions, states of one or more past intervention actions, one or more agent policies, and one or more intervention policies) via the data interface 215 and generate an output 250 which may be states of future intervention actions to maximize the intervention model's expected return. Examples of the input data may include the training data or states of an agent in test time. Examples of the output data may include states of an intervention to maximize the principal's expected return.

The data interface 215 may comprise a communication interface, a user interface (such as a voice input interface, a graphical user interface, and/or the like). For example, the computing device 200 may receive the input 240 (such as a training dataset) from a networked database via a communication interface. Or the computing device 200 may receive the input 240, such as states of an agent, from a user via the user interface.

In some embodiments, the model-based meta-learning module 230 is configured to train the neural network based agent model and the neural network based intervention model such that while the agent model learns to optimize its policy to maximize its reward, the intervention model learns to optimize its intervention policy based on the agent actions. The model-based meta-learning module 230 may further include an agent submodule 231 (e.g., similar to agent model 102 in FIGS. 1A-1) and an intervention submodule 232 (e.g., similar to intervention model 104 in FIGS. 1A-1). In some embodiments, model-based meta-learning module 230 includes an observable obtaining submodule that obtains the observables in FIG. 1B. In one embodiment, the model-based meta-learning module 230 and its submodules 231 and 232 may be implemented by hardware, software and/or a combination thereof.

In one embodiment, model-based meta-learning module 230 and one or more of its submodules 231-232 may be implemented via an artificial neural network. The neural network comprises a computing system that is built on a collection of connected units or nodes, referred as neurons. Each neuron receives an input signal and then generates an output by a non-linear transformation of the input signal. Neurons are often connected by edges, and an adjustable weight is often associated to the edge. The neurons are often aggregated into layers such that different layers may perform different transformations on the respective input and output transformed input data onto the next layer. Therefore, the neural network may be stored at memory 220 as a structure of layers of neurons, and parameters describing the non-linear transformation at each neuron and the weights associated with edges connecting the neurons. An example neural network may be framework 100, and/or the like.

In one embodiment, the neural network based model-based meta-learning module 230 and one or more of its submodules 231-232 may be trained by updating the underlying parameters of the neural networks, such as w of the agent model 102 and 0 of the intervention model 104. For example, the gradient of a training objective is computed with respect to each weight of each layer individually. Such negative gradient is computed one layer at a time, iteratively backward from the last layer to the input layer of the neural network. Parameters of the neural network are updated based on the computed negative gradient.

For example, the training objective of intervention model 104 (or intervention submodule 232) is to maximize how often meta-test-time agent model 102 (or agent submodule 231) choose a* during learning and have them converge to a policy that always chooses a*. To do so, intervention model 104 aims to maximize the cost-adjusted test-time return Jₜₑₛₜ^{p}(π^{p}, πⁱ)= [symbol] τₜₑₛₜ[Σₜ₌₁^{T} γ^{t-1}(rₜ^{p}−acₜ)], where agent model 102 executes its (optimal) policy πᵢ[π^{p}] in response to π^{p}:

$$\frac{arg max {𝔼}_{{τ}^{i} ∈ {T}_{t e s t}} {𝔼}_{π} p {𝔼}_{{π}^{i} [ {π}^{p} ]}}{{π}^{p}} [ {\sum }_{t = 1}^{T} {γ}^{t - 1} ( {r}_{t}^{p} - α {c}_{t} ) ] , {r}_{t}^{p} = 1 [ {a}_{t} = {a}^{*} ] , α > 0 , \qquad ( 1 )$$

where intervention model 104 incurs a cost cₜ if it intervenes, Tₜₑₛₜ is a set of meta-test time agents, T represents T time steps in an episode of intervention-agent interaction, τⁱ is an agent represented by agent model 102, πⁱ is agent i's policy, and π^{p} is the intervention policy, aₜ is agent action at time step t, γ is the discount factor, rₜ^{p} is the intervention model 104's reward at time step t, and α is a constant. A simple cost function is cₜ=1[r′ₜ≠0], i.e., the cost is constant across non-trivial interventions, where α>0. Note that if intervention were free (cₜ=0), a trivial solution is to always add a large r′(a*)>>0 for its preferred action a*, such that it always yields the highest reward. Hence, embodiments of the present disclosure focuses on learning non-trivial strategies when intervention is costly, which forces intervention model 104 to strategically alter agent model 102 learning behavior.

During an episode of T time steps, each agent i starts with a uniformly initialized action probability distribution πₒⁱ and optimizes πₜⁱ subject to interventions π^{p} to maximize its return: [symbol] _{π}_{ⁱ} [symbol] _{π}_{^{p}}[Σₜ₌₁^{T}\tilde{r}ₜⁱ(aₜⁱ, aₜ^{p})]. Here, it is assumed that T and γ are sufficiently large so agent model 102 converges to its optimal policy under \tilde{r}, using its learning algorithm ƒ. That is, it is assumed that the objective in Eq. (1) is sufficient to describe intervention model 104's objective of ensuring agent model 102 converges to preferring a* at some t<T.

In the K-shot adaptation setting, at meta-test time, intervention model 104 gets K episodes to interact with any agent represented by agent model 102, each episode of length T time steps. Intervention model 104 has a fixed intervention policy during an episode and it can update the intervention policy at the end of an episode. Agent model 102 is reset across episodes. Within each episode, agent model 102 follows its own learning strategy in response to the interventions. On the (K+1)^{th} episode, intervention model 104 evaluates its K-shot adapted policy on agent model 102. In some embodiments, it is assumed that intervention model 104 has a separate copy of the meta-test time agent for evaluation.

In another example, the training objective of agent model 102 (or agent submodule 231) is to maximize the log-likelihood of expected agent action described in

$$\frac{arg max {𝔼}_{{( {a}^{p} \sim π )}^{p}} {𝔼}_{{a}^{i} \sim {π}^{i}}}{ω} [ {\sum }_{t = 1}^{T} l og {\hat{π}}_{w} ( {a}_{t}^{i} \vert {a}_{t - 1}^{i} , {a}_{t - 1}^{p} , {h}_{t - 1}^{i} ) ] , \qquad ( 2 )$$

where a^{p} represents intervention, aⁱ represents agent action, πⁱ is agent i's policy, and π^{p} is the intervention policy, ω represents the parameters of agent model 102, T represents T time steps in an episode of intervention-agent interaction, \hat{π}_{w} represents intervention model 104's estimated agent action probability distribution, at is agent i's action at time step t, aₜ₋₁ⁱ is agent i's action at time step (t−1), aₜ₋₁ⁱ is intervention at time step (t−1), and hₜ₋₁ⁱ agent model 102's hidden state. The gradient of Eq. (2) is computed with respect to each weight of each layer individually. Such negative gradient is computed one layer at a time, iteratively backward from the last layer to the input layer of the neural network. Parameters o of agent model 102 are updated based on the computed negative gradient.

In some embodiments, agent submodule 231 and intervention submodule 232 may jointly train model-based meta-learning framework 100. Specifically, agent submodule 231 may train agent model 102, e.g., by updating the parameters of agent model 102 to maximize the log-likelihood of the expected agent action, and intervention submodule 232 may train intervention model 104, e.g., by updating the parameters of intervention model 104 to maximize an expected return of the intervention model. In some embodiments, agent submodule 231 updates the agent policy πⁱ at a time step t, computes a distribution over agent actions based on agent policy πⁱ, and execute/sample/select an agent action from the distribution. In some embodiments, intervention submodule 232 updates the intervention policy π^{p}, by updating parameters of intervention model 104, and select/generate an intervention from the intervention policy π^{p}. The executed/sampled agent action and generated intervention may be used in the training of framework 100.

Some examples of computing devices, such as computing device 200 may include non-transitory, tangible, machine readable media that include executable code that when run by one or more processors (e.g., processor 210) may cause the one or more processors to perform the processes of method. Some common forms of machine-readable media that may include the processes of method are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

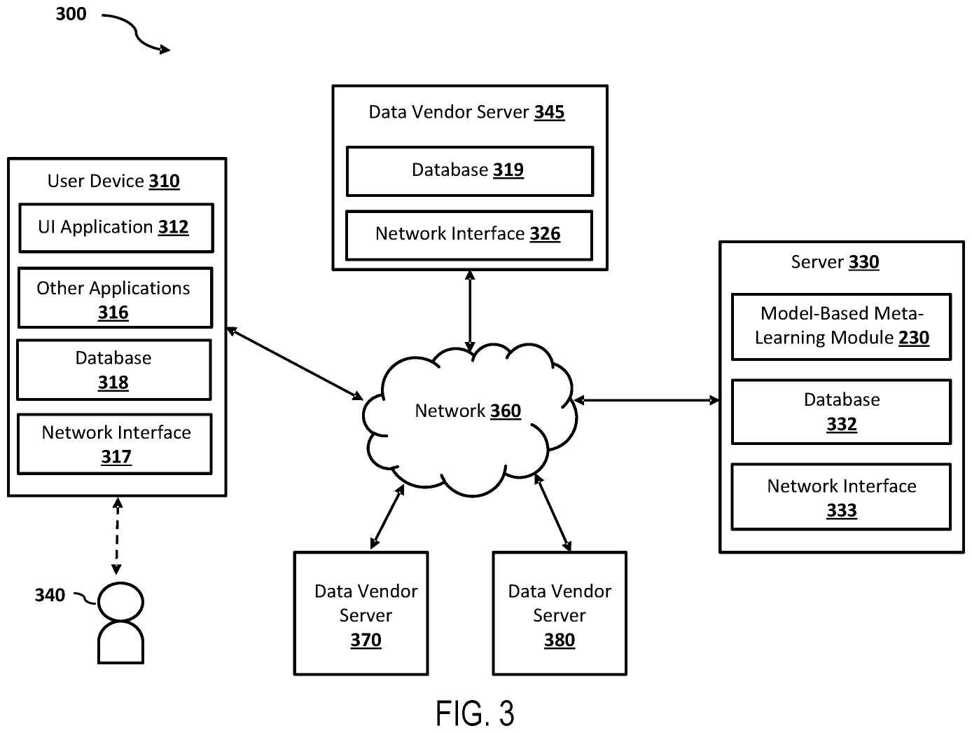

FIG. 3 is a simplified block diagram of a networked system suitable for implementing model-based meta-learning framework 100 described in FIGS. 1A, 1, 2, 4A, 4B, 5A-5D, and 6 and other embodiments described herein. In one embodiment, block diagram 300 shows a system including the user device 310 which may be operated by user 340, data vendor servers 345, 370 and 380, server 330, and other forms of devices, servers, and/or software components that operate to perform various methodologies in accordance with the described embodiments. Exemplary devices and servers may include device, stand-alone, and enterprise-class servers which may be similar to the computing device 200 described in FIG. 2, operating an OS such as a MICROSOFT® OS, a UNIX® OS, a LINUX® OS, or other suitable device and/or server-based OS. It can be appreciated that the devices and/or servers illustrated in FIG. 3 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entities.

The user device 310, data vendor servers 345, 370 and 380, and the server 330 may communicate with each other over a network 360. User device 310 may be utilized by a user 340 (e.g., a driver, a system admin, etc.) to access the various features available for user device 310, which may include processes and/or applications associated with the server 330 to receive an output data anomaly report.

User device 310, data vendor server 345, and the server 330 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 300, and/or accessible over network 360.

User device 310 may be implemented as a communication device that may utilize appropriate hardware and software configured for wired and/or wireless communication with data vendor server 345 and/or the server 330. For example, in one embodiment, user device 310 may be implemented as an autonomous driving vehicle, a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data, such as an IPAD® from APPLE®. Although only one communication device is shown, a plurality of communication devices may function similarly.

User device 310 of FIG. 3 contains a user interface (UI) application 312, and/or other applications 316, which may correspond to executable processes, procedures, and/or applications with associated hardware. For example, the user device 310 may receive a message indicating observables of agent actions and interventions, a predicted agent action, an intervention, and/or an executed agent action from the server 330 and display the message via the UI application 312. In other embodiments, user device 310 may include additional or different modules having specialized hardware and/or software as required.

In various embodiments, user device 310 includes other applications 316 as may be desired in particular embodiments to provide features to user device 310. For example, other applications 316 may include security applications for implementing client-side security features, programmatic client applications for interfacing with appropriate application programming interfaces (APIs) over network 360, or other types of applications. Other applications 316 may also include communication applications, such as email, texting, voice, social networking, and IM applications that allow a user to send and receive emails, calls, texts, and other notifications through network 360. For example, the other application 316 may be an email or instant messaging application that receives a prediction result message from the server 330. Other applications 316 may include device interfaces and other display modules that may receive input and/or output information. For example, other applications 316 may contain software programs for asset management, executable by a processor, including a graphical user interface (GUI) configured to provide an interface to the user 340 to view an intervention.

User device 310 may further include database 318 stored in a transitory and/or non-transitory memory of user device 310, which may store various applications and data and be utilized during execution of various modules of user device 310. Database 318 may store user profile relating to the user 340, predictions previously viewed or saved by the user 340, historical data received from the server 330, and/or the like. In some embodiments, database 318 may be local to user device 310. However, in other embodiments, database 318 may be external to user device 310 and accessible by user device 310, including cloud storage systems and/or databases that are accessible over network 360.

User device 310 includes at least one network interface component 317 adapted to communicate with data vendor server 345 and/or the server 330. In various embodiments, network interface component 317 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Data vendor server 345 may correspond to a server that hosts database 319 to provide training datasets including states of past agent actions and states of past interventions to the server 330. The database 319 may be implemented by one or more relational database, distributed databases, cloud databases, and/or the like.

The data vendor server 345 includes at least one network interface component 326 adapted to communicate with user device 310 and/or the server 330. In various embodiments, network interface component 326 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. For example, in one implementation, the data vendor server 345 may send asset information from the database 319, via the network interface 326, to the server 330.

The server 330 may be housed with the model-based meta-learning module 230 and its submodules described in FIG. 2. In some implementations, model-based meta-learning module 330 may receive data from database 319 at the data vendor server 345 via the network 360 to generate the agent actions. The generated agent actions may also be sent to the user device 310 for review by the user 340 via the network 360.

The database 332 may be stored in a transitory and/or non-transitory memory of the server 330. In one implementation, the database 332 may store data obtained from the data vendor server 345. In one implementation, the database 332 may store parameters of the model-based meta-learning module 230. In one implementation, the database 332 may store observables of agent actions, previously executed agent actions, and/or previously generated interventions, and the corresponding input feature vectors.

In some embodiments, database 332 may be local to the server 330. However, in other embodiments, database 332 may be external to the server 330 and accessible by the server 330, including cloud storage systems and/or databases that are accessible over network 360.

The server 330 includes at least one network interface component 333 adapted to communicate with user device 310 and/or data vendor servers 345, 370 or 380 over network 360. In various embodiments, network interface component 333 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 360 may be implemented as a single network or a combination of multiple networks. For example, in various embodiments, network 360 may include the Internet or one or more intranets, landline networks, wireless networks, and/or other appropriate types of networks. Thus, network 360 may correspond to small scale communication networks, such as a private or local area network, or a larger scale network, such as a wide area network or the Internet, accessible by the various components of system 300.

### Example Work Flows

FIG. 4A is an example logic flow diagram illustrating a method 400 for training the intervention model to learn the agent model using reinforcement learning based on the learning framework shown in FIGS. 1A, 1, 2, and 3, according to some embodiments described herein. One or more of the processes of method 400 may be implemented, at least in part, in the form of executable code stored on non-transitory, tangible, machine-readable media that when run by one or more processors may cause the one or more processors to perform one or more of the processes. In some embodiments, method 400 corresponds to the operation of the model-based meta-learning module 230 (e.g., FIGS. 2 and 3) that performs the training of the intervention model. FIGS. 1A and 1B illustrate method 400.

As illustrated, the method 400 includes a number of enumerated steps, but aspects of the method 400 may include additional steps before, after, and in between the enumerated steps. In some aspects, one or more of the enumerated steps may be omitted or performed in a different order.

At step 402, a first agent action at a first time step (aₜ₋₁ⁱ) and a first intervention (aₜ₋₁^{p}) are obtained. The first intervention is generated according to an intervention policy at the first time step (πₜ₋₁^{p}).

At step 404, a predicted agent action at a second time step (âₜⁱ) conditioned on the first agent action and the first intervention at the first time step is generated by a neural network based agent model (102).

At step 406, a second intervention at the second time step (aₜ^{p}) according to the intervention policy and conditioned on the first agent action is generated by a neural network based intervention model (104). In some embodiments, the generating of the second intervention at the second time step includes generating, by the neural network based intervention model, a distribution over interventions. In some embodiments, the generating of the second intervention also includes sampling the second intervention according to the generated distribution.

At step 408, a second agent action (aₜⁱ) is executed according to an agent policy (πₜⁱ) at the second time step that incurs a reward (\tilde{r}ₜ) that is based on the second intervention at the second time step. In some embodiments, the second agent action is determined by sampling the second agent action according to the agent policy at the second time step.

At step 410, the agent policy is updated (πₜ₋₁ⁱ) by maximizing a first expected return computed based on the incurred rewards including the incurred reward at the second time step, e.g., Eq. (2).

At step 412, the neural network based intervention model is trained by updating parameters (θ) of the neural network based intervention model based on a second expected return computed based on incurred rewards over a plurality of time steps, e.g., Eq. (1). In some embodiments, the second expected return is computed based on the incurred rewards and intervention costs (cₜ) associated with the interventions over the plurality of time steps. In some embodiments, the updating of the parameters of the neural network based intervention model is performed at an end of the plurality of time steps including the first time step and the second time step.

FIG. 4B is an example logic flow diagram illustrating a method 401 for training the intervention model to learn the agent model using meta-learning based on the learning framework shown in FIGS. 1A, 1, 2, and 3, according to some embodiments described herein. One or more of the processes of method 401 may be implemented, at least in part, in the form of executable code stored on non-transitory, tangible, machine-readable media that when run by one or more processors may cause the one or more processors to perform one or more of the processes. In some embodiments, method 401 corresponds to the operation of the model-based meta-learning module 230 (e.g., FIGS. 2 and 3) that performs the training of the intervention model.

As illustrated, the method 401 includes a number of enumerated steps, but aspects of the method 401 may include additional steps before, after, and in between the enumerated steps. In some aspects, one or more of the enumerated steps may be omitted or performed in a different order.

At step 403, a third agent action at a third time step and a third intervention are obtained. The third intervention is generated according to an intervention policy at the third time step. The third time step is after the plurality of time steps.

At step 405, a second predicted agent action at a fourth time step is generated by the neural network based agent model and is conditioned on the third agent action at the third time step, and a third intervention at the third time step.

At step 407, a fourth intervention at the fourth time step is generated, by a neural network based intervention model, according to the intervention policy after the plurality of time steps. The fourth intervention is conditioned on the third agent action, the third intervention, and the second predicted agent action.

At step 409, a fourth agent action at the fourth time step is executed. The fourth agent action incurs a reward that is based on the fourth intervention at the fourth time step.

At step 411, the agent policy is updated by maximizing a third expected return computed based on incurred rewards including the incurred reward at the fourth time step.

At step 413, a rollout including the fourth agent action, the fourth intervention, and an intervention distribution are collected after the plurality of time steps.

At step 415, the neural network is trained based intervention model by updating parameters of the neural network based intervention model based on collected rollouts over a second plurality of time steps. In some embodiments, method 401 further includes training the neural network based agent model by maximizing a log-likelihood of expected agent actions over the first or second plurality of time steps.

FIG. 5A provides an example pseudo-code segment (“Algorithm 1”) illustrating an example algorithm for training framework 100 shown in FIGS. 1A, 1B, 2, 3, 4A, and 4B. The training of framework 100 includes an inner loop (e.g., lines 6-11) and an outer loop (e.g., lines 12-17) in Algorithm 1. Framework 100 may train using reinforcement learning (“REINFORCE”) for the inner loop to learn the agent model (e.g., 102), and using meta-learning (“MAML”) for the outer loop to optimize the intervention model (e.g., 104) such that the intervention model is few-shot adaptable. In the training of framework 100, it is assumed that the meta-learning has Eₜᵣₐᵢₙ epochs; in each epoch, nₜᵣₐᵢₙ agents (represented by the agent model) may interact with the intervention model; each agent (represented by the agent model) may interact with the intervention model for Kₜᵣₐᵢₙ episodes; and in each episode, the agent model, representing an agent, may interact with the intervention model for T times (e.g., T time steps). In various embodiments, T can be equal to a few hundreds such as 100, 200, etc.

FIG. 5B provides an example logic flow diagram illustrating a method 500 for training framework 100 according to the algorithm in FIG. 5A, according to some embodiments described herein. One or more of the processes of method 500 may be implemented, at least in part, in the form of executable code stored on non-transitory, tangible, machine-readable media that when run by one or more processors may cause the one or more processors to perform one or more of the processes. In some embodiments, method 500 corresponds to an example operation of model-based meta-learning module 230 (e.g., FIGS. 2 and 3). For ease of illustration, FIG. 5B only shows the training of one meta-train epoch, e.g., from line 3 to line 17 of Algorithm 1.

As illustrated, method 500 includes a number of enumerated steps, but aspects of the method 500 may include additional steps before, after, and in between the enumerated steps. In some aspects, one or more of the enumerated steps may be omitted or performed in a different order.

At step 501, at the beginning of a meta-train epoch e, the parameters of the agent model (e.g., a neural network based model) is updated. Referring back to FIG. 5A, the parameters of agent model (e.g., 102) may be updated (e.g., by agent submodule 231) from ω to ωₑ using Eq. (2) for meta-train epoch e. In some embodiments, aₜ₋₁ⁱ and aₜ₋₁^{p} are respective observables of agent action and intervention at the beginning of the meta-train epoch e, and hₜ₋₁ⁱ is the hidden states of the agent model.

At step 502, the agent number (representing agent i) is set to be 1 for the interaction between the first agent (i.e., first task, represented by agent model 102 conditioned on states) and the intervention model (e.g., a neural network based intervention model 104).

At step 503, the parameters of the agent model and the intervention model (e.g., 102 and 104) may be initialized for the agent model (e.g., agent i), and k is set to be 1. Referring back to FIG. 5A, the agent model is initialized (e.g., by agent submodule 231) with (μⁱ, π₀ⁱ), and the intervention model is initialized (e.g., by intervention submodule 232) with task specific intervention policy parameter θ(τ₀ⁱ)=0, μⁱ represents agent i's true action mean rewards without intervention and indicates agent i's type, and π₀ⁱ represents agent i's uniformly initialized action probability distribution. θ(τ₀ⁱ), i.e., the initialized parameter of the intervention model, may be initialized with the parameters of the intervention model for meta-train epoch e. The episode number k is set to be 1 for the first episode.

At step 504, the time step number t is set to be 1 for the first time step that the agent model (representing agent i) interacts with the intervention model in a T intervention-agent interaction episode.

At step 505, at time step t and episode k, a predicted agent action is generated (e.g., by agent model 102), an intervention is generated based on an intervention policy of the episode (e.g., by intervention model 104), an agent action is executed that incurs a reward under the intervention (e.g., by agent model 102), and the agent policy is updated for the next time step (e.g., by agent submodule 231), e.g., time step (t+1).

Referring back to FIG. 5A, at time step t of episode k, the agent model may generate predicted agent action âₜⁱ as âₜⁱ=argmaxₐ_{ₜ}_{ⁱ}\hat{π}_{w}(aₜⁱ|aₜ₋₁ⁱ, aₜ₋₁^{p}, hₜ₋₁ⁱ). Predicted agent action a may be generated based on agent action (e.g., observable) aₜ₋₁ⁱ at time step (t−1), intervention (observable) aₜ₋₁^{p} at time step (t−1), and the hidden state hₜ₋₁ⁱ of the agent model at time step (t−1). The intervention model may then generate/sample the intervention aₜ^{p}˜πθ_{(τ}_{ₖ}_{ⁱ}₎^{p} (aₜ^{p}|aₜ₋₁ⁱ, aₜ₋₁^{p}, âₜⁱ, hₜ₋₁^{p}), and result in agent i's intervened reward \tilde{μ}₁=μⁱ+aₜ^{p}. Intervention aₜ^{p} may be generated/selected based on the intervention policy π_{θ(τ}_{ₖ}_{ⁱ}₎^{p} for the agent model (representing agent i) in episode k, and may result in a cost and a reward of the intervention model. The intervention policy π_{θ(τ}_{ₖ}_{ⁱ}₎^{p} may be determined based on agent i's action aₜ₋₁ⁱ at time step (t−1), intervention aₜ₋₁^{p} at time step (t−1), predicted agent i's action âₜⁱ, and the hidden state hₜ₋₁^{p} of the intervention model at time step (t−1). In some embodiments, the intervention policy π_{θ(τ}_{ₖ}_{ⁱ}₎^{p} includes the intervention on each possible agent action, i.e., aₜ^{p}=[r′₁, . . . , r′_{|A|}].

The agent model may execute/select agent action aₜⁱ (observable) based on its policy πₜⁱ for time step t and receive reward rₜⁱ sampled from N(\tilde{μ}ⁱ, σ²). In some embodiments, at time step t, a distribution over agent i's actions is computed using agent policy πₜⁱ based on the observations for agent action up to time step t (e.g., by agent submodule 231), and the agent model executes aₜⁱ sampled from πₜⁱ. The agent policy is then updated (e.g., by agent submodule 231) for time step (t+1), e.g., πₜⁱ [symbol] πₜ₊₁ⁱ. In some embodiments, at time step t, an update rule (e.g., a learning algorithm) ƒ: (πₜⁱ, aₜⁱ, \tilde{r}ₜⁱ) [symbol] πₜ₊₁ⁱ is used (e.g., by agent submodule 231) to maximize agent i's intervened rewards it. In some embodiments, the agent policy πₜⁱ subject to πₜ^{p} is optimized (e.g., by agent submodule 231) to maximize agent's return [symbol] _{π}_{ⁱ} [symbol] _{π}_{^{p}}[Σₜ₌₁^{T}\tilde{r}ₜⁱ(aₜⁱ, aₜ^{p})]. That is, the agent policy πₜⁱ is updated after a (e.g., each) time step in an episode. In some embodiments, a function ƒ is used (e.g., by agent submodule 231) to update the confidence bounds for the action selected at time step t.

At step 506, it is determined whether t has reached T. If t is equal to T, method 500 proceeds to step 508. If t is not equal to T (e.g., t<T), method 500 proceeds to step 507, in which t is increased by 1. Method 500 then loops back to step 505 from step 507.

At step 508, the parameters of the intervention model are updated (e.g., by intervention submodule 232). Referring back to FIG. 5A, the intervention model updates its parameters/policy using θ(τₖⁱ) [symbol] θ(τₖ₊₁ⁱ), e.g., after (e.g., each) episode k. In some embodiments, the intervention model maximizes the cost-adjusted test-time return by updating its parameters/policy based on Eq. (1).

At step 509, it is determined whether k has reached Kₜᵣₐᵢₙ. If k is equal to Kₜᵣₐᵢₙ, method 500 proceeds to step 511, in which the time step number t is set to be 1. If k is not equal to Kₜᵣₐᵢₙ (e.g., k<Kₜᵣₐᵢₙ), method 500 proceeds to step 510, in which the episode number k is increased by 1. Method 500 then loops back to step 504 from step 510.

At step 512, at time step t, a predicted agent action is generated (e.g., by agent model 102), an intervention is generated based on an intervention policy at Kₜᵣₐᵢₙ (e.g., by intervention model 104), an agent action is executed (e.g., by agent model 102) that incurs a reward under the intervention, the agent policy is updated for the next time step (e.g., by agent submodule 231), e.g., time step (t+1), and a rollout of the agent model representing agent i (e.g., including agent i's action, the predicted intervention, and the intervention policy at Kₜᵣₐᵢₙ) is collected. Referring back to FIG. 5A, at time step t after the Kₜᵣₐᵢₙ episodes, a rollout of the agent model representing agent i may be performed. The agent model may generate predicted agent action âₜⁱ as argmaxₐ_{ₜ}_{ⁱ}\hat{π}_{w}(aₜⁱ|aₜ₋₁ⁱ, aₜ₋₁^{p}, hₜ₋₁ⁱ). Predicted agent action âₜⁱ may be generated based on agent action (e.g., observable) aₜ₋₁ⁱ at time step (t−1), intervention (observable) aₜ₋₁^{p} at time step (t−1), and the hidden state hₜ₋₁ⁱ of the agent model at time step (t−1). The intervention model may then generate/sample the predicted intervention

$${a}_{t}^{p} ∼ {π}_{θ ( {τ}_{{k}_{train}}^{i} )}^{p} ( {a}_{t}^{p} \vert {a}_{t - 1}^{i} , {a}_{t - 1}^{p} , {â}_{t}^{i} , {h}_{t - 1}^{p} ) ,$$

and result in the agent model (representing agent i)'s intervened reward \tilde{μ}ⁱ=μⁱ+aₜ^{p}. Predicted intervention aₜ^{p} may be generated/selected based on the intervention policy

$${π}_{θ ( {τ}_{{K}_{t r a i n}}^{i} )}^{p}$$

for the agent model (representing agent i) for episodes Kₜᵣₐᵢₙ. The intervention policy

$${π}_{θ ( {τ}_{{K}_{t r a i n}}^{i} )}^{p}$$

may be determined based on agent i's action aₜ₋₁ⁱ at time step (t−1), intervention aₜ₋₁^{p} at time step (t−1), predicted agent i's action âₜⁱ, and the hidden state hₜ₋₁^{p} of the intervention model at time step (t−1). In some embodiments, the intervention model determines its intervention based on the intervention policy

$${π}_{θ ( {τ}_{{K}_{t r a i n}}^{i} )}^{p}$$

for each possible agent action, i.e., aₜ^{p}=[r′₁, . . . , r′_{|A|}]. The agent model may execute/select agent action aₜⁱ (observable) based on its policy πₜⁱ for time step t and receive reward rₜⁱ sampled from N(\tilde{μ}ⁱ, σ²). In some embodiments, at time step t, a distribution over agent i's actions is computed based on agent policy πₜⁱ using the observations for the agent up to time step t, and execute aₜⁱ sampled from πₜⁱ. The agent policy may be updated for time step (t+1), e.g., πₜⁱ [symbol] πₜ₊₁ⁱ. In some embodiments, at time step t, the agent model learns by using an [symbol] update rule ƒ: (πₜⁱ, aₜⁱ, \tilde{r}ₜⁱ) [symbol] πₜ₊₁ⁱ to maximize agent i's intervened rewards \tilde{r}ₜⁱ. In some embodiments, the agent model (representing agent i) optimizes its policy πₜⁱ subject to πₜ^{p} to maximize its return [symbol] _{π}_{ⁱ} [symbol] _{π}_{^{p}}[Σₜ₌₁^{T}\tilde{r}ₜⁱ(aₜⁱ, aₜ^{p})]. In some embodiments, a function ƒ is used (e.g., by agent submodule 231) to update the confidence bounds for the action selected at time step t. The intervention model may collect rollout for the agent model representing agent i,

$${D}_{meta} ( {τ}^{i} ) ⋃ \{ {a}_{t}^{i} , {a}_{t}^{p} , {π}_{θ ( {τ}_{{k}_{train}}^{i} )}^{p} \} ,$$

e.g., agent action aₜⁱ, predicted intervention aₜ^{p}, and intervention policy

$${π}_{θ ( {τ}_{{K}_{t r a i n}}^{i} )}^{p} .$$

At step 513, it is determined whether t has reached T. If t is not equal to T (e.g., t<T), method 500 proceeds to step 514, in which the time step number t is increased by 1. Method 500 then loops back to step 512 from step 514. If t is equal to T, method 500 proceeds to step 515, in which it is determined whether i has reached nₜᵣₐᵢₙ. If i is not equal to nₜᵣₐᵢₙ (e.g., i<nₜᵣₐᵢₙ), method 500 proceeds to step 516, in which the agent number i is increased by 1. Method 500 then loops back to step 503 from step 516. If i is equal to nₜᵣₐᵢₙ, method 500 proceeds to step 517. Method 200 then loops back to step 501 from step 517.

At step 517, the parameters of the intervention model is updated. The intervention model may meta-update its parameters θₑ [symbol] θₑ₊₁ using the collected rollout Dₘₑₜₐ=U_{τ}_{ⁱ}Dₘₑₜₐ(τⁱ).

Referring back to FIG. 5A, framework 100 is trained using reinforcement learning (“REINFORCEMENT”) and meta-learning (“MAML”). Specifically, reinforcement learning is used in the inner loop to train the intervention model to learn from the agent model (e.g., line 6-line 11 of Algorithm 1). While the agent policy is updated/optimized sequentially/continuously during an episode, the intervention model may locally update its parameter at the end of each episode. After an episode ends, the intervention model starts a rollout using gradient-based meta-learning in an outer loop (e.g., line 12-line 17) to meta-update the parameters/policy. The intervention model may meta-update its parameters when all the agents (e.g., nₜᵣₐᵢₙ agents), represented by the agent model, have interacted with the intervention model.

In some embodiments, the trained framework 100 may be used to generate interventions over agent actions of test agents, represented by the trained agent model, at a test time. A test agent may be a bandit agent of which the distribution/policy is different from the training agents in the training process, and the trained agent model may be conditioned on corresponding states/observables to represent the test agent. For example, a bandit agent may be sequential learners and the agent model may update its policy πⁱ differently at different time steps. In some embodiments, an intervention a^{p} may not equally incentivize the bandit agent (represented by the agent model) at different time steps. At the test time, the agent model may have K episodes of interaction with the intervention model, the parameters of the agent model is not updated, and the parameters of the intervention model is updated. In various embodiments, K is a small positive integer such as 1, 2, 3, etc. In an embodiment, K is equal to 1 and i is equal to 1 (only one test agent), and framework 100 may re-train using a method similar to method 500 such that the intervention model is K-shot adaptable. FIG. 5C provides an example pseudo-code segment (“Algorithm 2”) illustrating an example algorithm for testing and evaluating framework 100 shown in FIGS. 1A, 1, 2, 3, 4A, and 4B. FIG. 5D illustrates an example method 520 using Algorithm 2 for learning from a bandit agent in K-shot test time in one episode, according to some embodiments. Method 520 may be a simplified version of method 500 when k is equal to 1 (K=1), i is equal to 1 (nₜₑₛₜ=1), and step 501 is skipped (e.g., the parameters of the agent model is not updated).

At step 521, the parameters of the agent model and the intervention model (e.g., 104) may be initialized for an agent.

At step 522, the time step number t is set to be 1 for the first time step that the agent model interacts with the intervention model in a T intervention-agent interaction episode.

At step 523, at time step t, a predicted agent action is generated, an intervention is generated based on an intervention policy of the episode, an agent action is executed from an agent policy after training (e.g., illustrated in FIGS. 5A and 5B) that incurs a reward under the intervention, and the agent policy is updated for the next time step, e.g., time step (t+1).

At step 524, it is determined whether t has reached T. If t is equal to T, method 520 proceeds to step 526. If t is not equal to T (e.g., t<T), method 520 proceeds to step 525, in which t is increased by 1. Method 520 then loops back to step 523 from step 525.

At step 526, the parameters of the intervention model are updated.

At step 527, the time step number t is set to be 1.

At step 528, at time step t, a predicted agent action is generated, an intervention is generated based on an intervention policy at time step t, an agent action is executed from the agent policy after training (e.g., illustrated in FIGS. 5A and 5B) that incurs a reward under the intervention, the agent policy is updated for the next time step, e.g., time step (t+1), and a principal's score is updated. In an embodiment, the principal's score is an evaluation of the principal's payoff from the interaction.

At step 529, it is determined whether t has reached T. If t is not equal to T (e.g., t<T), method 520 proceeds to step 530, in which the time step number t is increased by 1. Method 520 then loops back to step 528 from step 530. If t is equal to T, method 520 proceeds to step 531, in which the method ends.

### Example Data Experiments Performance

Example data experiments are performed with a sequential general-sum game between the intervention model (representing a principal) and the agent model (representing an adaptive no-regret learner agent). The bandit agent is modeled by an |A|-armed bandit instance with action set A having base reward r=[r₁, . . . , r_{|A|}]. At each time step t, the agent model chooses an arm a and gets a reward sampled from N(rₐ, σ²). It is assumed that rₐ∈(0,1)∀a. The agent model aims to maximize its cumulative reward over a horizon of T steps. The agent model can only observe the reward for the chosen action, and hence faces a explore-exploit dilemma addressed by bandit algorithms like UCB (Lai et al., Asymptotically Efficient Adaptive Allocation Rules, Advances in Applied Mathematics, 6(1): 4-22, 1985). It is assumed that there is a unique arm a with the highest base reward: ã=arg maxₐrₐ, i.e., the agent's preferred action without any intervention.

To analyze the effect of the cost of intervention cₜ on the intervention model's learnt intervention policy, we assume that the intervention model decides among three different intervention levels |r′|∈{0, 0.5, 1} such that cₜ=|r′|. Across different bandit agent tasks τⁱ with distinct base rewards r′ and reward gaps 8=max_{a∈A} rⁱ[a]−rⁱ[a*], the intervention model may learn to appropriately incentivize the agent model while minimizing the total cost of intervening. It is then defined that the experienced reward as: \tilde{r}ₜ[a*]=rⁱ[a*]+r′ₜ; \tilde{r}ₜ[a]=rⁱ[a]−r′ₜ,∀a≠a*, (a, a*∈A).

It is noted that this may ensure that the agent model always experiences an intervention, no matter which action it chooses. During each episode, the agent model learns but the intervention policy is fixed; the intervention model can update the intervention policy only at the end of each episode (referring back to Algorithm 1 in FIG. 5A). Also, it is assumed that the intervention model can only observe the agent actions aₜⁱ but not its base reward rⁱ or policy update function ƒⁱ. The performance of the intervention model may be measured using Eq. (1), with γ=1.

The agent model may predict the agent's next action (given the intervention model's prior observations) to characterize the agent's behavior. The agent model may not be trained to estimate the base rewards, because bandit agents with distinct base rewards could still execute the same sequence of actions, depending on the agent model's explore-exploit algorithm and its observations.

The intervention policy learning with sequential (bandit) agents may create additional challenges. First, bandit agents (represented by the agent models) may follow different strategies for action selection to maximize their experienced reward. The agent's rate of exploration may be constant (e.g., ϵ-greedy) or it can reduce with time (e.g., UCB) within an episode, depending on its observations. This may create a highly non-stationary environment for the intervention model wherein its decision to intervene must adapt to different explore-exploit behaviors for the same agent within an episode. When the agent explores a larger action space, it further exacerbates the challenges in estimating the agent action since the intervention model only has partial information about the agent model. Further, bandit agents may be sequential learners and feedback (aₜⁱ, \tilde{r}ₜⁱ) can update the policy πⁱ differently at different steps t. The update may depend on how optimistic (e.g., UCB) or pessimistic (e.g., EXP3) the bandit agents are about their reward estimates. Hence, an intervention a^{p} may not equally incentivize the agent model at different t. Since the interventions have different costs, a strategic intervention model must decide when to intervene and how much (|r′|) depending on its observations of the agent actions.

In the experiments, 15 bandit agents are used for training and 10 bandit agents are used for testing, each with different base rewards (both within and across train and test sets). |A| is equal to 10. Two agent learning algorithms (UCB and ϵ-greedy) are considered. In each experiment, the train and test agents use the same algorithm, but with different tendencies for exploration vs exploitation, determined by their exploration coefficients: β∈{0.17, 0.27, 0.42, 0.5, 0.67} for UCB (higher β gives more exploration) and ϵ∈{0.1, 0.2, 0.3, 0.4, 0.5} for ϵ-greedy (higher c gives more exploration). These constants were chosen such that they afford, on the average, the same number of exploratory actions when following either UCB or ϵ-greedy strategy without any intervention.

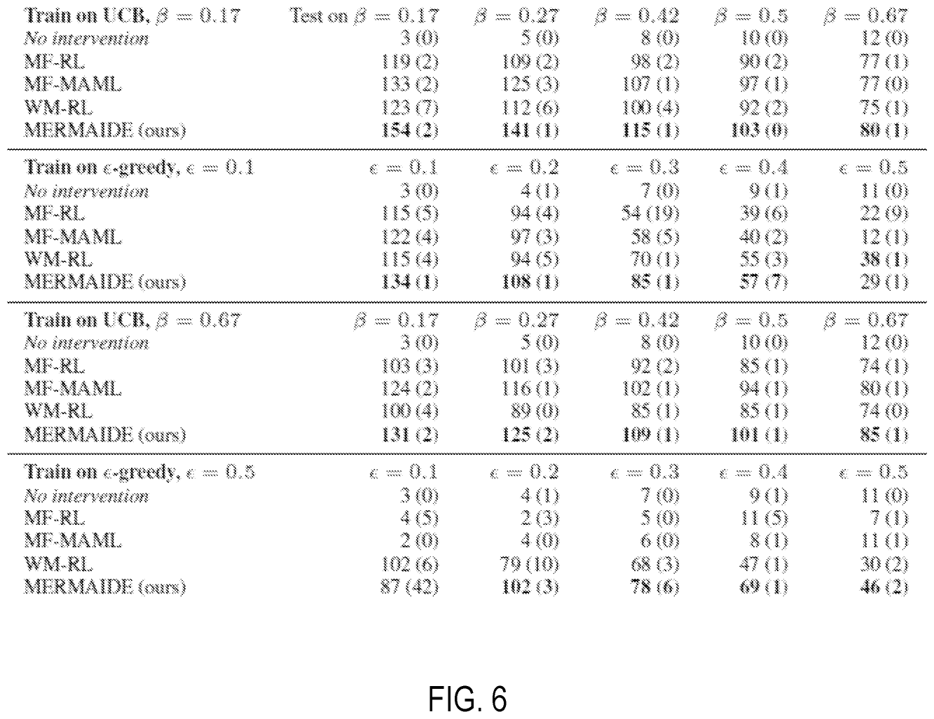

In FIG. 6, it is shown that the one-shot adapted intervention's score on each test set over T=200 time steps. The model-based meta-learning model (e.g., framework 100) is compared against 1) model-free baselines (model-free reinforcement learning (MF-RL) using REINFORCE and model-free meta-learning (MFMAML) using MAML), as well as 2) REINFORCE with agent model (WM-RL). A “No Intervention” baseline is also included to show how agents behave by default.

FIG. 6 shows the intervention's score when evaluated on test agents having a different exploration constant than train agents. Using meta-learning for the intervention policy (MF-MAML) and using an agent model to predict the agent's behavior (WM-RL) both have advantages for training a robust and one-shot adaptable intervention policy. An agent model is advantageous when 1) the test agent is more exploratory than the train set (e.g., ϵ=0.1 at training, ϵ=0.4 at test), or 2) the agent explores (e.g., represented by the settings of the agent model) throughout an episode and is likely to often select actions other than the one with its current maximum mean reward estimate (e.g., ϵ=0.5 at training). Because K being equal to 1 is evaluated, fine-tuning on only a single test-time episode, and a trained world model provides a useful prior belief representation for the principal. Indeed, the MF-RL results show the hidden state representation of the model-free principal might be unable to adapt to high environment non-stationarity without a trained next-agent-action world model.

Compared to an ϵ-greedy agent, the UCB agent explores mostly at the start of an episode, for all β. Hence, with UCB agents, the intervention model learns an effective one-shot adaptable intervention policy using meta-learning (MF-MAML) only (even without an agent model), as the agents cause less distribution shift across different c. It further emphasizes the effectiveness of meta-learning for adaptive policy learning: unlike MF-MAML, neither the agent model nor the intervention policy is meta-learned in WM-RL. Moreover, it also shows that for the same amount of distribution shift, the relative benefit of an agent model or meta-learning the intervention policy depends on the nature of the agent's exploration strategy (which is unknown to the principal).

In all, these results show that the model-based metal learning model (e.g., framework 100) combines the best of both techniques: the intervention model (representing the principal) obtains a higher score across agents with different learning algorithms and explore-exploit behaviors.

In order to intervene effectively, the intervention model should learn when to intervene and how much to incentivize the agent model while minimizing its incurred cost. This is a challenging learning problem for the principal not just during meta-training, but more so during one-shot adaptation at meta-test time. Bandit algorithms like EXP3 (The Nonstochastic Multi-Armed Bandit Problem. Auer et al., SIAM Journal On Computing, 32(1):48-77, 2002) use pessimism in the face of uncertainty, and encourage continued exploration. This increases the non-stationarity for the principal. In order to effectively incentivize such agents to prefer a*, the intervention model needs to accurately predict the agent policy from its observations; otherwise, it can incur a high cost for intervening ineffectively and lowering its score, and learn to stop intervening. Indeed, the results when training on ϵ=0.5-greedy agents show that the MF-RL and MF-MAML intervention model stop intervening. In contrast, in that setting, the disclosed model-based meta-learning model learns an effective intervention policy that outperforms all baselines, even under distribution shift between meta-train and meta-test agents.

This description and the accompanying drawings that illustrate inventive aspects, embodiments, implementations, or applications should not be taken as limiting. Various mechanical, compositional, structural, electrical, and operational changes may be made without departing from the spirit and scope of this description and the claims. In some instances, well-known circuits, structures, or techniques have not been shown or described in detail in order not to obscure the embodiments of this disclosure. Like numbers in two or more figures represent the same or similar elements.

In this description, specific details are set forth describing some embodiments consistent with the present disclosure. Numerous specific details are set forth in order to provide a thorough understanding of the embodiments. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

Although illustrative embodiments have been shown and described, a wide range of modification, change and substitution is contemplated in the foregoing disclosure and in some instances, some features of the embodiments may be employed without a corresponding use of other features. One of ordinary skill in the art would recognize many variations, alternatives, and modifications. Thus, the scope of the intervention should be limited only by the following claims, and it is appropriate that the claims be construed broadly and, in a manner, consistent with the scope of the embodiments disclosed herein.

What is claimed is:

1. A method for predicting agent actions for a plurality of neural network based agents according to an intervention input, the method comprising:
obtaining a first agent action at a first time step and a first intervention that is generated according to an intervention policy at the first time step;
generating, by a neural network based agent model, a predicted agent action at a second time step conditioned on the first agent action, and the first intervention at the first time step;
generating, by a neural network based intervention model, a second intervention at the second time step according to the intervention policy and conditioned on the first agent action, the first intervention, and the predicted agent action;
executing a second agent action according to an agent policy at the second time step that incurs a reward that is based on the second intervention at the second time step; and
training the neural network based intervention model by updating parameters of the neural network based intervention model based on a first expected return computed based on incurred rewards over a plurality of time steps.

2. The method of claim 1, wherein the first expected return is computed based on the incurred rewards and intervention costs associated with the interventions over the plurality of time steps.

3. The method of claim 1, further comprising:
updating the agent policy by maximizing a second expected return computed based on incurred rewards including the incurred reward at the second time step, prior to the updating of the parameters of the neural network based intervention model.

4. The method of claim 1, wherein the second agent action is determined by sampling the second agent action according to the agent policy at the second time step.

5. The method of claim 1, wherein the generating of the second intervention at the second time step includes:
generating, by the neural network based intervention model, a distribution over interventions; and
sampling the second intervention according to the generated distribution.

6. The method of claim 1, wherein the updating of the parameters of the neural network based intervention model is performed at an end of the plurality of time steps including the first time step and the second time step.

7. The method of claim 1, further comprising, after training the neural network based intervention model:
generating, by the neural network based agent model, a second predicted agent action at a fourth time step conditioned on a third agent action at a third time step, and a third intervention at the third time step, the third time step being after the plurality of time steps;
generating, by a neural network based intervention model, a fourth intervention at the fourth time step according to the intervention policy after the plurality of time steps and conditioned on the third agent action, the third intervention, and the second predicted agent action;
executing a fourth agent action at the fourth time step that incurs a reward that is based on the fourth intervention at the fourth time step;
collecting a rollout including the fourth agent action, the fourth intervention, and an intervention distribution after the plurality of time steps; and
training the neural network based intervention model by updating parameters of the neural network based intervention model based on collected rollouts over a second plurality of time steps.

8. The method of claim 7, further comprising training the neural network based agent model by maximizing a log-likelihood of expected agent actions over the first or second plurality of time steps.

9. A system for predicting agent actions for a plurality of neural network based agents according to an intervention input, the system comprising:
a memory that stores a neural network based agent model and a neural network based intervention model, and a plurality of processor executable instructions;
a communication interface that receives a first agent action at a first time step and a first intervention that is generated according to an intervention policy at the first time step; and
one or more hardware processors that read and execute the plurality of processor-executable instructions from the memory to perform operations comprising:
generating, by a neural network based agent model, a predicted agent action at a second time step conditioned on the first agent action, and the first intervention at the first time step;
generating, by a neural network based intervention model, a second intervention at the second time step according to the intervention policy and conditioned on the first agent action, the first intervention, and the predicted agent action;
executing a second agent action according to an agent policy at the second time step that incurs a reward that is based on the second intervention at the second time step; and
training the neural network based intervention model by updating parameters of the neural network based intervention model based on a first expected return computed based on incurred rewards over a plurality of time steps.

10. The system of claim 9, wherein the first expected return is computed based on the incurred rewards and intervention costs associated with the interventions over the plurality of time steps.

11. The system of claim 9, wherein the operations further comprise:
updating the agent policy by maximizing a second expected return computed based on incurred rewards including the incurred reward at the second time step, prior to the updating of the parameters of the neural network based intervention model.

12. The system of claim 9, wherein the second agent action is determined by sampling the second agent action according to the agent policy at the second time step.

13. The system of claim 9, wherein the generating of the second intervention at the second time step includes:
generating, by the neural network based intervention model, a distribution over interventions; and
sampling the second intervention according to the generated distribution.

14. The system of claim 9, wherein the updating of the parameters of the neural network based intervention model is performed at an end of the plurality of time steps including the first time step and the second time step.

15. The system of claim 9, wherein the operations further comprise, after training the neural network based intervention model:
generating, by the neural network based agent model, a second predicted agent action at a fourth time step conditioned on a third agent action at a third time step, and a third intervention at the third time step, the third time step being after the plurality of time steps;
generating, by a neural network based intervention model, a fourth intervention at the fourth time step according to the intervention policy after the plurality of time steps and conditioned on the third agent action, the third intervention, and the second predicted agent action;
executing a fourth agent action at the fourth time step that incurs a reward that is based on the fourth intervention at the fourth time step;
collecting a rollout including the fourth agent action, the fourth intervention, and an intervention distribution after the plurality of time steps; and
training the neural network based intervention model by updating parameters of the neural network based intervention model based on collected rollouts over a second plurality of time steps.

16. The system of claim 15, wherein the operations further comprise
training the neural network based agent model by maximizing a log-likelihood of expected agent actions over the first or second plurality of time steps.

17. A non-transitory machine-readable medium comprising a plurality of machine-executable instructions which, when executed by one or more processors, are adapted to cause the one or more processors to perform operations comprising:
obtaining a first agent action at a first time step and a first intervention that is generated according to an intervention policy at the first time step;
generating, by a neural network based agent model, a predicted agent action at a second time step conditioned on the first agent action, and the first intervention at the first time step;
generating, by a neural network based intervention model, a second intervention at the second time step according to the intervention policy and conditioned on the first agent action, the first intervention, and the predicted agent action;
executing a second agent action according to an agent policy at the second time step that incurs a reward that is based on the second intervention at the second time step; and
training the neural network based intervention model by updating parameters of the neural network based intervention model based on a first expected return computed based on incurred rewards over a plurality of time steps.

18. The non-transitory machine-readable medium of claim 17, wherein the first expected return is computed based on the incurred rewards and intervention costs associated with the interventions over the plurality of time steps.

19. The non-transitory machine-readable medium of claim 17, wherein the operations further comprise:
updating the agent policy by maximizing a second expected return computed based on incurred rewards including the incurred reward at the second time step, prior to the updating of the parameters of the neural network based intervention model.

20. The non-transitory machine-readable medium of claim 17, wherein the operations further comprise, after training the neural network based intervention model:
generating, by the neural network based agent model, a second predicted agent action at a fourth time step conditioned on a third agent action at a third time step, and a third intervention at the third time step, the third time step being after the plurality of time steps;
generating, by a neural network based intervention model, a fourth intervention at the fourth time step according to the intervention policy after the plurality of time steps and conditioned on the third agent action, the third intervention, and the second predicted agent action;
executing a fourth agent action at the fourth time step that incurs a reward that is based on the fourth intervention at the fourth time step;
collecting a rollout including the fourth agent action, the fourth intervention, and an intervention distribution after the plurality of time steps; and
training the neural network based intervention model by updating parameters of the neural network based intervention model based on collected rollouts over a second plurality of time steps.
